(19) United States
(12) Patent Application Publication
(10) Pub. No.: US 2007/0215712 A1
(43) Pub. Date: Sep. 20, 2007

(54) Method and Device for Atomizing Liquid Films

(76) Inventors: Karl Rimmer, Kostenberg (AT); Gunther Schulz, Goslar (DE)

Correspondence Address: YOUNG & THOMPSON, 745 SOUTH 23RD STREET, 2ND FLOOR, ARLINGTON, VA, 22202, US

(21) Appl. No.: 11/628,162

(22) PCT Filed: Jun. 16, 2005
(86) PCT No.: PCT/AT05/00213

§ 371 Date: Jan. 3, 2007

(30) Foreign Application Priority Data
Jun. 17, 2004 (AT) A 1027/2004

(51) Int. Cl. B05B 7/02

(52) U.S. Cl. 239/8; 239/399

(57) ABSTRACT

A method for atomizing liquid films to fine droplets (2), wherein the liquid (2) is discharged from an elongate slotted nozzle (3) in the shape of a straight film. The outlet opening of the slotted nozzle (3) is located inside a linear Venturi nozzle (5) in whose divergent section linear gas outlet openings (7) (Laval nozzles) are provided and impinged upon by gas (6). The negative pressure produced in the area of the Laval nozzles (7) draws in gas flows (4) from the gas chambers (1), located at both sides of the liquid film and delimited by the convergent section of the Venturi nozzle (5). Said gas flows stabilize the liquid film in such a manner that it is atomized to a tent-shaped cone of liquid droplets only after passage of the narrowest point of the Venturi nozzle (5).

The invention relates to a process and a device for atomizing liquid films.

The atomization of liquids by gas spraying is known.

For example, a process for the production of metal powders is known from DE 197 58 111 A. In this known process, the metal melt emerges in the form of a film from a melt nozzle with a slot-shaped exhaust opening. The film is stabilized by a laminar gas flow in a Laval gas nozzle and then finely atomized. The productivity of the nozzle system can be altered as desired by extending the nozzle slot without disadvantageous effects on the powder quality.

The Laval nozzle that is used in the process according to DE 197 58 111 A has a convergent-divergent geometry according to definition and has at least the critical pressure ratio of the gas that is used in front of and behind the nozzle.

The necessity that the liquid that is to be sprayed (melt) has to be introduced into the melt nozzle under high pressure, for example 25 bar, is disadvantageous in the process that is described in DE 197 58 111 A. This requires costly, large pressure vessels. During the atomization of metal melts, the production and the processing of larger amounts of melts at elevated temperatures in a pressure vessel can be evaluated critically from the standpoint of safety, the cost is increased, and the industrial-scale application of the process is inhibited. In addition, a process for the atomization of liquids with the aid of gas is indicated according to EP A 0 444 767, whereby the liquid is allowed to emerge in the form of a film from a linear liquid slotted nozzle. Within a linear convergent-divergent Venturi nozzle, the liquid film is stabilized by a laminar, subcritical reactant gas flow. This process shows the drawback, however, that the liquid to be sprayed must be introduced into the melt nozzle only under relatively high pressure. Here, the invention is intended to correct this.

The object of the invention is to make available a process and a device that is suitable for performing the same, which allows the (industrial) fine atomization of liquid films for the production of fine droplets from metal melts, without the processing expense of the preparation and processing of a melt that is under high pressure.

This object is achieved with a process that has the features of claim 1 and with a device that has the features of the independent main claim of the device.

Preferred and advantageous configurations of the invention are the subject of the subclaims.

With the process according to the invention, the atomization of liquid films that have been stabilized before the atomization by a parallel-flowing, laminar gas flow, whose speed is lower than the speed of sound (“subcritical gas flow”) is possible with the aid of gas jets. The process according to the invention is suitable for the production of fine powders, which are formed from the liquid droplets after the atomization by cooling and solidification. In addition, semifinished products from these drops of metal melts can be produced with the process according to the invention by solidification of the same on a suitable substrate. Finally, the process according to the invention is also suitable for the production of powders by, e.g., spray-drying, if the atomized liquid is a solution or a dispersion.

Surprisingly enough, the stabilization of liquid films, in particular melt films, is possible according to the invention even with a subcritical, laminar gas flow, which is produced in a convergent-divergent Venturi nozzle. To this end, the process according to the invention—depending on the embodiment—requires only a small subcritical overpressure or even no overpressure in front of the inflow section of the Venturi nozzle in comparison to the pressure in the outflow section of the Venturi nozzle.

The liquid film that is stabilized with the process according to the invention is not atomized directly after passing through the narrowest point of the Venturi nozzle, but rather decomposes first at a significant distance from its narrowest point because of instabilities and under the influence of the surface tension of the melt.

In an embodiment of the invention, the liquid film can be created in the area of the stretches between the narrowest point of the Venturi gas nozzle and the spontaneous decay point by one or more flat linear gas jets and can be atomized in a directed manner.

The preliminary pressure of the spraying gas emerging from the linear gas nozzles can be set to adjust the powder fineness independently of the preliminary pressure of the reactant gas flow stabilizing the liquid film. The higher the preliminary pressure of the actual spraying gas is set, the smaller are the particles achieved by the atomization according to the invention.

In an embodiment of the invention, it is possible to set the pressure difference, necessary in the stabilization of the liquid film in the Venturi nozzle, by the intake action of the actual atomizing gas jets. To this end, the geometry of the atomizing gas jets is selected so that a completely enclosed space develops below the Venturi nozzle. The thus produced space can also be limited by components on the two ends of the linear Venturi nozzle.

The atomizing jets behave like free jets and take in gas particles from the gas atmosphere going around it. To this end, an underpressure arises in the intake area. The underpressure in the volume enclosed by the atomizing gas jets in the discharge section of the Venturi nozzle causes a pressure drop to be produced relative to the gas chamber in the intake section of the Venturi nozzle, by which a flow in the Venturi nozzle is formed. In the gas chamber above the Venturi nozzle, the pressure is kept constant by introducing gas, such that finally constant pressure and flow properties are set. The reactant gas flow in the Venturi nozzle can now be used to stabilize the melt film.

Additional details of the invention follow from the description, below, of exemplary embodiments of devices for performing the process. Here:

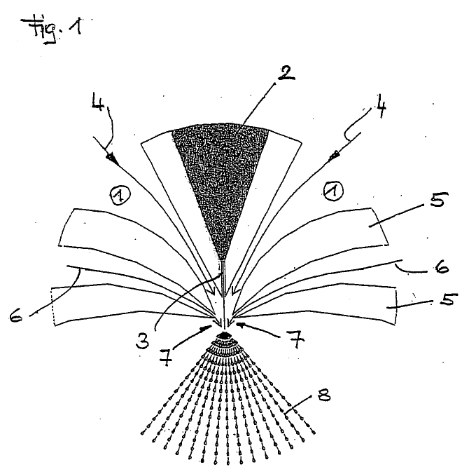

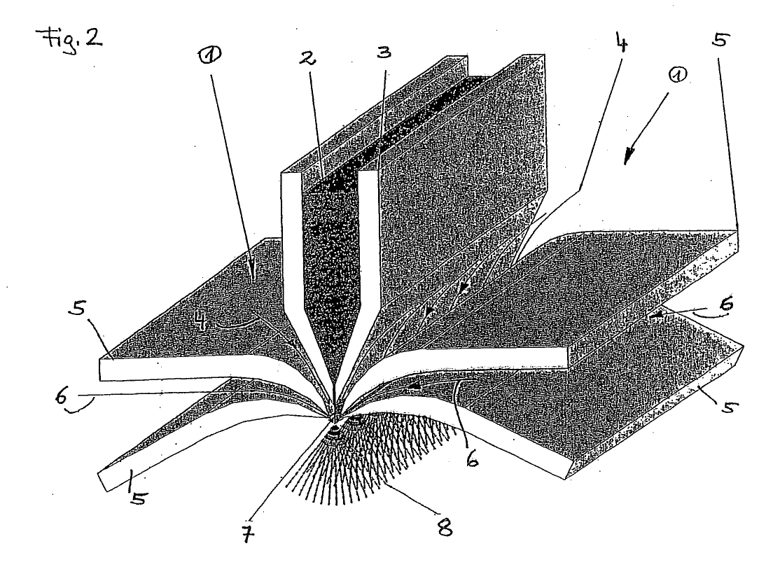

FIG. 1 shows diagrammatically and in side view an arrangement for atomization according to the invention, and FIG. 2 shows in oblique view another embodiment of a device according to the invention.

Although the invention is described below by way of example with reference to a metal melt as a “liquid,” it is not limited to metal melts but rather is suitable for the atomization of any liquids with the purpose of producing fine liquid droplets.

In the embodiment shown in FIG. 1, metal melt 2 is fed, increasingly tapered, to a melt nozzle 3. The nozzle 3 has a slot-shaped exhaust opening, so that the melt emerges therefrom in a film-like manner. One gas nozzle 5 each, which is formed like a Venturi nozzle, is provided on both sides of the film at a distance below the exhaust openings of the melt nozzle 3, and atomizing gas that is symbolized by the arrow 6 is fed linearly to said gas nozzles 5.

An underpressure that takes in gas from the gas chamber 1 in the direction of arrow 4 is produced by the gas that emerges from the gas nozzles 5. The gas flows that are taken in in the direction of the arrow 4 and that strike the melt film from both sides stabilize the melt film that emerges from the nozzle 3. The melt film is atomized into a tent-like particle spray cone 8 only in the area of the openings of the gas nozzle 5.

FIG. 2 again shows in oblique view the arrangement that is shown diagrammatically in FIG. 1. It can be seen that even here, the melt film that emerges from the nozzle 3 under the action of the atomizing gas jets (more linear jets), which emerge from the gas nozzles 5, is atomized into a tent-like particle spray cone 8.

Below, non-limiting examples of the process according to the invention are described.

### EXAMPLE 1

### Underpressure at a Venturi Nozzle Caused by the Intake Effect of the Atomizing Gas Jets

A tin melt at a temperature of 300° C. flows out from a linear melt nozzle with an exhaust opening with a 0.5 mm width and a 30 mm length. The melt mass flow is 4.6 kg/minute. The Venturi nozzle consists of two individual nozzles with one slot-like gas exhaust nozzle each of the dimensions of 40 mm in length and 0.5 mm in width. The atomizing gas pressure in front of the gas nozzle is 0.6 MPa. The angle between the atomizing gas nozzles is 60°. The distance between the two linear Venturi nozzles is 6 mm at the narrowest point. Air is used as a spraying gas and as a stabilizing gas. A stabilizing gas flow is built up by the entire Venturi nozzle. In this gas flow, the melt film that emerges from the melt nozzle is fed, stabilized and finally atomized. After the metal droplets are solidified, a powder with an average grain size d₅₀ of 37 μm that is measured by laser granulometry is obtained.

### EXAMPLE 2

### Lower Overpressure Above the Venturi Nozzle

A tin melt with a mass flow of 5.1 kg/min emerges from a linear melt nozzle with a rectangular opening of 0.7×20 mm. The overpressure of the reactant gas stabilizing the melt film in front of the Venturi nozzle is 0.85 bar, and the boiler overpressure behind the Venturi nozzle is 0.02 bar. 5 mm below the narrowest point of the Venturi nozzle, the melt film, which is stable up to that point, is hit by two flat gas jets that flow out from linear Laval nozzles with a narrowest cross-section of 0.5×35 mm and strike in a line together with the melt film. The pressure of the spraying gas in front of the linear Laval nozzles is 28 bar. The film is atomized, and after the droplets are solidified, a powder product with an average grain diameter d₅₀ of 9.1 μm is obtained. The specific gas consumption is 1.7 Nm³/kg of powder when using nitrogen as a reactant gas and spraying gas.

### EXAMPLE 3

In this example, the procedure was performed just as in Example 2, whereby, however, a pressure difference is produced by suctioning off in the waste gas system such that a vacuum pump below the Venturi nozzle produces an underpressure of 0.02 MPa.

The average grain size is 9.3 μm, and the specific gas consumption is 1.4 Nm³/kg of powder.

In summary, an embodiment of the invention can [be] to atomize liquid films into fine droplets, the liquid 2 is allowed to emerge in the form of a straight film from an elongated slotted nozzle 3. The exhaust opening of the slotted nozzle 3 is found within a linear Venturi nozzle 5, in whose divergent part linear gas exhaust openings 7 (Laval nozzles) are embedded, which are supplied with gas 6. The underpressure that arises in the area of the Laval nozzles 7 causes gas flows 4 to be suctioned off from the gas chamber 1, which is limited by the convergent part of the Venturi nozzle 5 and covered on both sides by the liquid film, and said gas flows stabilize the liquid film so that the latter is atomized into a tent-like cone that consists of liquid droplets only after the passage through the narrowest point of the Venturi nozzle 5.

1. Process for the atomization of liquids with the aid of gas, characterized in that the liquid is allowed to emerge in the form of a film from a linear liquid nozzle, in that the film is stabilized by a laminar, subcritical reactant gas flow within a linear convergent-divergent Venturi nozzle, and in that the liquid film is atomized below the narrowest point of the Venturi nozzle by a spraying gas, whereby the spraying gas emerges from at least one gas nozzle, preferably at least one linear gas nozzle, in the divergent part of the Venturi nozzle.

2. Process according to claim 1, wherein the ratio of the gas pressure in front of the Venturi nozzle to the gas pressure behind the Venturi nozzle is selected to be smaller than the critical pressure ratio of the reactant gas that is used.

3. Process according to claim 1, wherein the preliminary pressure in front of at least one gas nozzle, from which the spraying gas emerges, is selected to be less than 200 bar, preferably less than 35 bar.

4. Process according to claim 1, wherein the pressure difference that is necessary to produce the stabilizing reactant gas flow is produced by the suctioning-off of gas parts through the jet of spraying gas that emerges from at least one gas nozzle.

5. Process according to claim 1, wherein the pressure difference that is necessary for producing the stabilizing reactant gas flow is produced in such a way that an elevated pressure level is set above the Venturi nozzle.

6. Process according to claim 1, wherein the pressure difference that is necessary for producing the stabilizing reactant gas flow is produced by the suctioning-off of gas below the Venturi nozzle.

7. Process according to claim 1, wherein the jets of spraying gas have angles of varying size relative to the liquid film emerging from the nozzle, such that the liquid film is atomized first from the spraying gas jet emerging at a larger angle; conversely, the second spraying gas jet emerging at a smaller angle atomizes for a second time the aerosol that is produced under the action of the first spraying gas jet.

8. Process according to claim 1, wherein the liquid to be sprayed is a melt of a metal or an alloy, a salt, a plastic, a wax or a sugar.

9. Process according to claim 1, wherein the liquid to be atomized is a solution or a suspension.

10. Process according to claim 9, wherein the droplets that are formed from the liquid by atomization are spray-dried.

11. Device for performing the process according to claim 1, wherein a nozzle with a longitudinally-elongated exhaust slot for the liquid to be atomized, in particular the melts, is provided, wherein longitudinally-elongated slot-like openings for the intake of reactant gas flows stabilizing liquid films emerging from the nozzle (3) are provided on both sides of the exhaust opening of the nozzle (3), and wherein at the distance below the melt nozzle, at least one nozzle is provided for the discharge of gas atomizing the liquid film.

12. Device according to claim 11, wherein the Venturi nozzle and the gas nozzles, from which the spraying gas emerges, form a structural unit.

13. Device according to claim 11, wherein the Venturi nozzle and the gas nozzles, from which the spraying gas emerges, form separate components.

14. Device according to one of claims 11 to 13, wherein two gas nozzles, from which spraying gas emerges, are provided.

15. Device according to claim 11, wherein two gas nozzles are arranged at the same angle relative to the liquid film emerging from the longitudinally-elongated slotted nozzle (3), i.e., symmetrically.

16. Device according to claim 11, wherein the gas nozzles, from which the spraying gas emerges, are oriented at different angles, i.e., asymmetrically.

17. Device according to claim 11, wherein the gas nozzles, from which the spraying gas emerges, are Laval nozzles.

18. Process according to claim 2, wherein the preliminary pressure in front of at least one gas nozzle, from which the spraying gas emerges, is selected to be less than 200 bar, preferably less than 35 bar.

19. Process according to claim 2, wherein the pressure difference that is necessary to produce the stabilizing reactant gas flow is produced by the suctioning-off of gas parts through the jet of spraying gas that emerges from at least one gas nozzle.

20. Process according to claim 3, wherein the pressure difference that is necessary to produce the stabilizing reactant gas flow is produced by the suctioning-off of gas parts through the jet of spraying gas that emerges from at least one gas nozzle.
